(19) United States
(12) Patent Application Publication
(10) Pub. No.: US 2011/0310101 A1
(43) Pub. Date: Dec. 22, 2011

(54) PILLAR GRID CONVERSION

(75) Inventors: David Michael Prange, Somerville, MA (US); Thibaut Klein, Eaubonne (FR); Hugues A. Djikpesse, Cambridge, MA (US)

(73) Assignee: SCHLUMBERGER TECHNOLOGY CORPORATION, Sugar Land, TX (US)

(21) Appl. No.: 12/820,379

(22) Filed: Jun. 22, 2010

(51) Int. Cl. G06T 17/30

(52) U.S. Cl. 345/420

(57) ABSTRACT

One or more computer-readable media include computer-executable instructions to instruct a computing system to access data that define a pillar grid where pillar nodes of the pillar grid define logical cells of a reservoir model, partition the pillar grid into subvolumes, build surfaces to define boundaries for each of the subvolumes where each of the surfaces includes polygons defined by surface nodes, generate a mesh of property nodes for each of the subvolumes where at least some of the property nodes include properties derived from properties of the reservoir model, and store data that define the subvolumes, the surfaces and the meshes. Other examples include a method of processing information for subsequent visual presentation with respect to a reservoir model and techniques for merging models. Various other apparatuses, systems, methods, etc., are also disclosed.

### BACKGROUND

Techniques to aid recovery of material from a reservoir include model-based simulation techniques. For example, so-called pillar grid models are used commonly to simulate fluid flow in reservoirs. Pillar grid models are computationally efficient representations because they are logically Cartesian, i.e., any cell in the model can be identified by a three tuple (i, j, k) in a Cartesian domain. However, pillar grids can misrepresent complex geometrical structures, especially in the neighborhood of geometrical or property discontinuities. This lack of geometrical accuracy can manifest in voids and other geometrical errors. With respect to voids, in a geometrical domain, these may be viewed as “leaky” holes between two volumetric cells (e.g., where each of the cells is defined by 8 points with two points on each of four pillars). The lack of geometrical accuracy and associated issues (e.g., “leaks”) render pillar grids unsuitable for modeling various types of physical phenomena, e.g., seismic waves, electromagnetic waves and geomechanical stress fields. Various techniques described herein can allow for conversion of a pillar grid model into a “watertight” model suited for modeling of various types of physical phenomena that require geometrical integrity.

### SUMMARY

One or more computer-readable media include computer-executable instructions to instruct a computing system to access data that define a pillar grid where pillar nodes of the pillar grid define logical cells of a reservoir model, partition the pillar grid into subvolumes, build surfaces to define boundaries for each of the subvolumes where each of the surfaces includes polygons defined by surface nodes, generate a mesh of property nodes for each of the subvolumes where at least some of the property nodes include properties derived from properties of the reservoir model, and store data that define the subvolumes, the surfaces and the meshes. Other examples described herein include a method of processing information for subsequent visual presentation with respect to a reservoir model and techniques for merging models. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a pillar grid model that includes a fault that results in a void for the model in a geometrical domain;

FIG. 2 illustrates an example method for converting a pillar grid model to a subvolume, surface and mesh model, capable of representing faults in a geometrical domain;

FIG. 3 illustrates an example of a reservoir model and an example of a conversion process for converting a pillar grid model of the reservoir to a subvolume, surface and mesh model of the reservoir that allows for modeling of one or more types of phenomena;

FIG. 4 illustrates a portion of a pillar grid model and examples of surface patches for conversion of the pillar grid model to a subvolume, surface and mesh model;

FIG. 5 illustrates an example of an index system for representing subvolumes in a subvolume, surface and mesh model, as converted from a grid pillar model;

FIG. 6 illustrates an example of projecting a 3D pillar grid model to reduce dimensionality to a 2D representation to model intersecting bounding lines between nodes at a fault and an example of subvolumes and an intermediate node at a fault or other boundary;

FIG. 7 illustrates examples of collapsed and half-collapsed cells as well as undefined pillars and undefined cells;

FIG. 8 illustrates an example of a model in a geometrical domain and in a logical domain to address issues associated with collapsed cells;

FIG. 9 illustrates an example method for fetching nodes (or points) and for assigning properties and a specific example for a cell in a model;

FIG. 10 illustrates examples of property assignment for a node in a first cell and for a node in a second, different cell;

FIG. 11 illustrates examples for modeling a partially penetrating fault for a rectangular mesh (or grid) that defines hexahedrons and a triangular mesh that defines tetrahedrons;

FIG. 12 illustrates an example of a merging method that merges two models; and

FIG. 13 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Two types of models are traditionally used for representing geological structures in the oil and gas industry: pillar grid models and Volcan models. Pillar grid models are composed of individual pillars that typically define, in a logical Cartesian space, hexahedral cells. The indices of these cells are Cartesian-ordered, for example, using a (i, j, k) index for each node of a pillar or corner of a cell. Pillar grids are popular for reservoir simulation because the Cartesian cell ordering allows a simulator to efficiently address model cells, while preserving an ability to describe the geometrical and numerical discontinuities between cells necessary to represent fault networks and fine-scale stratification. The main limitation of pillar grids is that, while they are able to describe a broad range of reservoir geometries, there are many reservoir configurations, such as salt domes, that pillar grids are topologically unable to describe. This limitation is compounded when a zone of interest is expanded to include a complex overburden in addition to the reservoir, with the result that most such models cannot be described by a pillar grid. Hence pillar grids are typically not used for modeling applications that require overburden description, such as for seismic and geomechanical simulation.

Where modeling of phenomena requires that certain geometry conditions be met, pillar grids present issues that either prevent solutions or result in inaccurate solutions. Hence, where particular geometry conditions exist, the constraint of being logically Cartesian is often dropped, which allows a model to more accurately describe geometry, including complex geometry. As described herein, certain models are referred to as “Volcan” models, for example, as currently used for seismic ray tracing applications.

A Volcan model includes a set of possibly overlapping meshes that describe subvolumes where each subvolume is separated from its neighbor by a surface. Each subvolume can be described by a tetrahedral mesh, a Cartesian grid or, in principle, any geometry system capable of describing that subvolume. Each surface separating two subvolumes can be described by a triangulated surface mesh, a Cartesian grid or, in principle, any geometry system capable of describing that surface.

As a Volcan model decouples property description from geometry of subvolumes, a modeler is freed from matching property population methods with subvolume boundary constraints. For example, properties can be represented by a regular grid even though the subvolume boundary is arbitrarily complex. This is possible because bounding surfaces act as “cookie cutters” that extract only the part of the property grid that is interior to the bound surfaces.

As described herein, for a model that includes subvolumes, surfaces and meshes, a surface mesh may have nodes in common with a subvolume's property mesh or a surface mesh may be independent of a subvolume's property mesh. Where a property mesh extends beyond any surface of a subvolume, the surface (e.g., or surface mesh) may be used to cut the property mesh (e.g., to extract only the part of the property grid that is interior to the bounding surfaces).

With respect to Volcan data structure, surfaces can be implemented as indexed triangulated meshes with triangle connectivity information. In other words, a data structure can hold an array of node positions and another array of triangles that includes indices to both triangle nodes and to neighboring triangles (i.e., the ones they share an edge with). Surfaces define the boundaries of each sub-part of a Volcan model.

The pillar grid and Volcan models are clearly quite different in nature and are used for different applications; however, modern seismic-to-simulation workflows contain iterative loops in which the workflow progresses from seismic to simulation and back again until the interpretation is complete. This type of progressive iteration necessitates conversions from detailed pillar grid models at the reservoir level to Volcan models that include both reservoir and overburden components.

As described herein, various methods allow for efficient and accurate conversion of a pillar grid model to a more accurate geometric volume model such as the aforementioned Volcan model. Such methods can allow geoscientists to assess better the impact of reservoir complexity, both by allowing seismic models to include the complexity of the reservoir pillar grid model in the context of a complex overburden model, and by allowing such reservoir-level simulations as geomechanical behavior to extend their pillar grid models to the surface using potentially complex overburden models.

A particular example of a conversion method includes: 1) partitioning cells of a pillar grid into subvolumes (or subsets) having continuous geometry and properties within each subvolume (or subset); 2) generation of watertight triangulated surfaces (e.g., surface meshes) that bound these subvolumes (or subsets) via extraction of information from a pillar grid; and 3) tessellation of a property mesh, ultimately bounded by the “watertight” surfaces to produce watertight subvolumes and surfaces suitable for representation of geometry, for example, as in a Volcan model.

As described herein, a mesh may be a grid, but in various instances the term “mesh” is used to distinguish a pillar grid model from a model that includes subvolumes, surfaces and property meshes such as in a Volcan model; noting that each surface typically has an associated surface mesh. Further, as different types of surfaces occur in nature, a conversion process may account for characteristics of each type of surface (e.g., a fault, a horizon, a geobody, etc.). For example, a conversion process may be programmed to identify a salt dome and construct one or more surfaces to describe the salt dome for purposes of modeling.

The complexity of the aforementioned conversion method may be max(n, nᵥf(n/nᵥ)) where n is the number of cells in the pillar grid, f(x) is the cost of populating a grid with x points and nᵥ is the number of subvolumes in the output model.

Also described herein, is an example of a hybrid modeling method for merging a converted pillar grid model with a subvolume, surface and mesh model (e.g., Volcan model) representing other parts of the subsurface (e.g., over- and under-burden and shale diapirs).

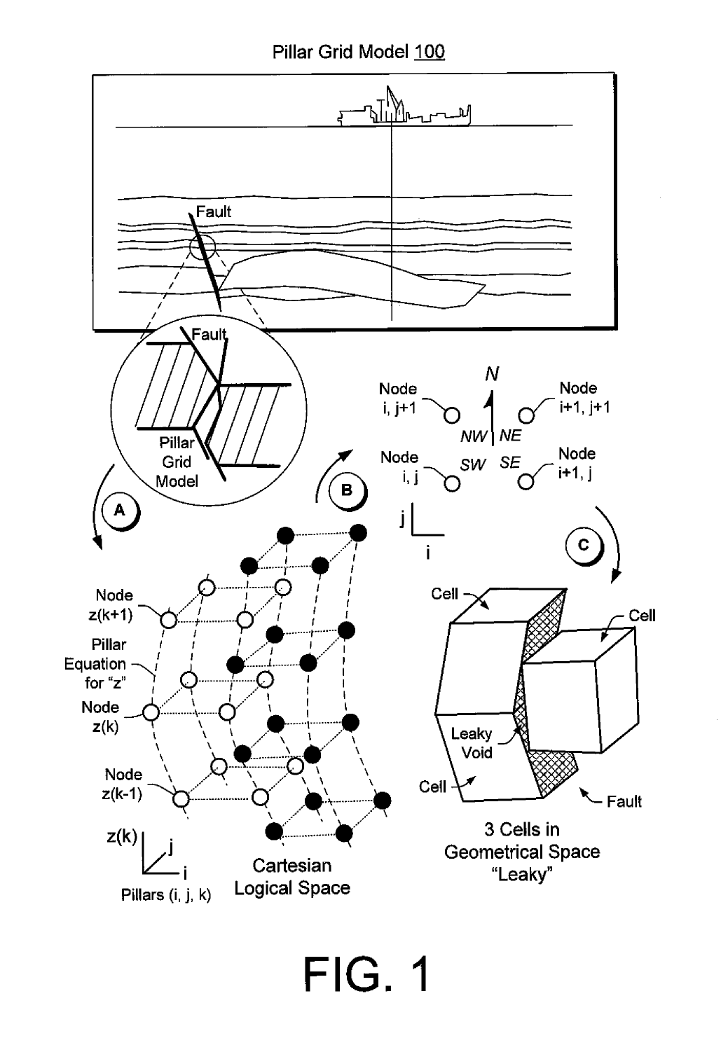

FIG. 1 shows an example of a pillar grid model 100 for modeling geologic features. As shown, the geology includes a fault. Pillars exist on the fault where nodes are located according to an equation that depends on a “k” index of a logical, Cartesian coordinate system. While “Cartesian” is mentioned, for a pillar grid, the indices shown (i, j, k) mainly serve to logically locate, store and retrieve information germane to pillars. In essence, the pillar grid model 100 of FIG. 1 is a connection model where properties are assigned and connections are defined, with solutions facilitated by the simple (i, j, k) tuple.

A portion of the pillar grid representing a fault region is shown (see arrow “A”). In this portion, the filled nodes represent matter on one side of the fault and the open nodes represent matter on the other side of the fault. In the portion shown, the nodes of both sides at the fault are represented by equations for two pillars. By inserting an integer index value “k” into an equation, a “z” value results.

Referring to arrow “B”, to define cells in a pillar grid model, so-called “directions” of nodes are considered. For example, for a given “k”, the SW corner of node (i, j), the NW corner of node (i, j+1), the NE corner of node (i+1, j+1), and the SE corner of node (i+1, j) define a top or bottom side of a cell.

Referring to arrow “C”, in a geometrical space, the 3 cells (2 cells on one side of the fault and 1 cell on the other side of the fault) result in a void. As described herein, a void is associated with a so-called “leaky” model. In other words, in the geometrical space, the cells are not contiguous and do not share surfaces. Instead, each cell has its own surface. In a pillar grid model, such surfaces may be interrelated, but they are not intimate or shared in the sense that each cell has its own distinct surfaces according to its definition in the logical space. As the logical space dictates the nature of the pillar grid model, the geometrical space can have peculiarities that confound modeling of phenomena that require geometric integrity (e.g., such as volumes that share surfaces).

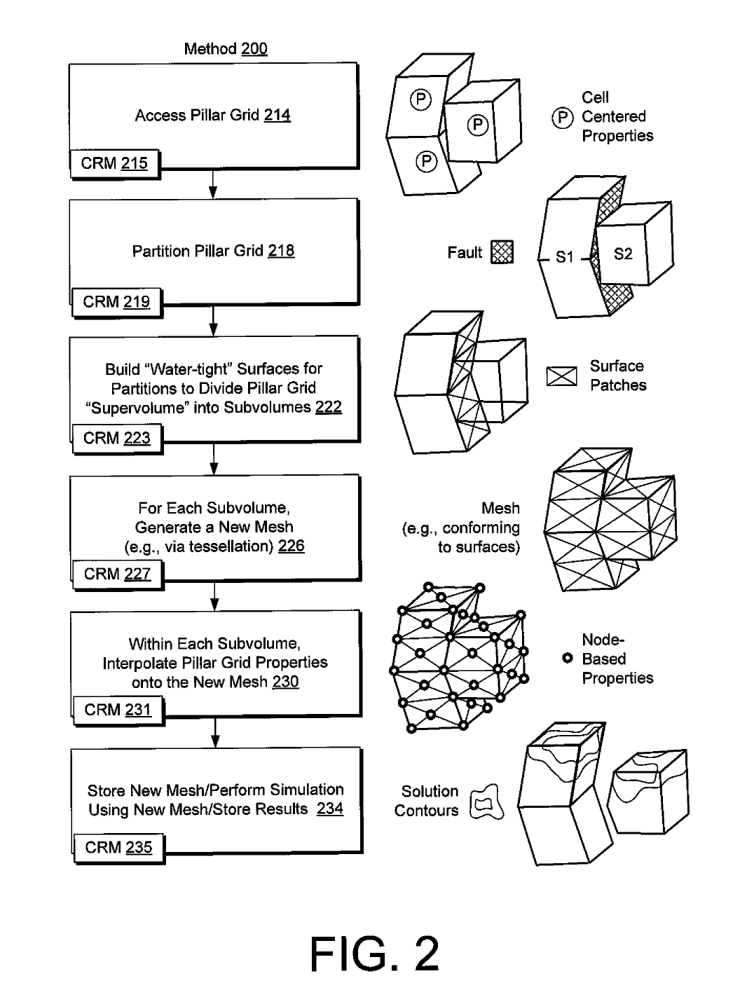

FIG. 2 shows an example of a method 200 along with simplified graphical representations of the three cells of a “leaky” pillar grid model (see, e.g., the 3 cells of FIG. 1) being converted to a “watertight” model that includes subvolumes, surfaces and mesh. Such a model is, at times referred to herein as a subvolume, surface and mesh model or “SSM” model. The blocks of the method 200 optionally have one or more corresponding computer-readable medium (CRM) that include instructions for instructing a computing device or devices to perform at least a portion of the method 200. In the example of FIG. 2, various CRM blocks are shown: 215, 219, 223, 227, 231 and 235. While multiple blocks are shown, a single CRM may include instructions sufficient to instruct a computing device (or devices) to perform the actions in each of the blocks of the method 200.

In a provision or access block 214, a pillar grid model is provided or accessed. For example, a data set may be provided with indices (i, j, k) and properties and connections associated with these indices. Such a data set may be in the form of one or more computer-readable media, optionally for transmission via a wired or wireless connection. As shown in FIG. 2, the properties for the pillar grid are defined on a cell-centered basis, although other property representations, such as tri-linear interpolation from the nodes, are possible. Accordingly, each cell has one set of properties, which are considered to be homogeneous throughout the cell, as considered in a geometrical space.

In a partition block 218, the pillar grid model is partitioned. For example, partitioning may occur along real geologic features such as a fault or a horizon (bottom, top, other surface, etc.). Partitioning may also consider sides to define a finite three-dimensional volume within a pillar grid model supervolume. Of course, depending on modeling approach or phenomena to be modeled, equations may eventually be provided for surfaces that represent “infinite” boundary conditions (e.g., consider a model with one or more infinite bounding sides of particular material properties to reduce overall number of nodes, equations, etc.). In the example of FIG. 2, the pillar grid model is partitioned along the fault into a first segment (Segment 1) and a second segment (Segment 2).

In a construction block 222, surfaces are built to address the “leaky” nature of the cells of the pillar grid in the geometrical space. For example, as mentioned, the nodes along the fault are represented by an equation that depends on a “k” integer index. As five “k” values are required, logically, for circumstances specific to the example of FIG. 2 (some other circumstances are described elsewhere herein), five “patch” surfaces may be constructed, which, ultimately will serve as surfaces common to subvolumes in Segment 1 and Segment 2 that lie along the fault. In the simplified diagram accompanying block 222, five patch surfaces are shown as being triangulated, noting that other types of polygons may be used.

In a volume fill or tessellation block 226, the nodes defined by the triangulated patch surfaces are used as a basis to volume fill or tessellate volume elements which generate a property mesh in each of the subvolumes. In the example shown, tetrahedral volume elements are used, which match the triangulated patch surfaces; noting, for example, hexahedral volumes may be suitable where the patch surfaces include a rectangular mesh instead of a triangular mesh. Further, as mentioned, a property mesh may be circumscribed about a subvolume. In such an example, the surfaces act to define the portion of the property mesh that is relevant to a particular subvolume.

In a property assignment block 230, properties are assigned to each node of a subvolume. For example, properties associated with the pillar grid may be used to perform such an assignment process. Additional properties may also be assigned or completely new properties may be assigned (e.g., depending on the desires or goals of a modeler).

In a storage or solution block 234, the SSM model with associated node-based properties is stored (e.g., to memory) for later use where it may be relied on to provide a solution; alternatively, a solution may be sought upon conversion of the pillar grid model. In the example of FIG. 2, Segment 1 and Segment 2 are shown in an exploded view to illustrate solution contours along the fault, which is a shared surface for these two segments. For example, solution results may be stored and then presented for subsequent visual presentation with respect to a reservoir model.

Accordingly, as described herein a method can include providing a pillar grid, partitioning the pillar grid into subvolumes within which properties vary smoothly and where discontinuities occur at, for example, zone and fault boundaries, constructing “watertight” surfaces that divide the pillar grid (the supervolume) into subvolumes. A mesh is constructed that completely fills the subvolume and may overlap with neighboring subvolumes (e.g., and one or more other meshes), interpolating within each subvolume pillar grid properties onto the new mesh (noting that where subvolumes were chosen such that there are no discontinuities in the property values, a suitable interpolation can generally be found), and using the new subvolume, surface and mesh model for simulating one or more phenomena.

In the simplified diagrams of the example of FIG. 2, the cells of the pillar grid are partitioned into subsets having continuous geometry and properties within each subset, watertight triangulated surfaces that bound these subsets are extracted from the pillar grid, and the subvolumes bounded by these watertight surfaces are tessellated to produce the watertight subvolumes with associated surfaces and property meshes.

As described herein, one or more computer-readable media can include computer-executable instructions to instruct a computing system to access data that define a pillar grid where pillar nodes of the pillar grid define logical cells of a reservoir model, partition the pillar grid into subvolumes, build surfaces to define boundaries for each of the subvolumes where each of the surfaces comprises polygons defined by surface nodes, generate a mesh of property nodes for each of the subvolumes where at least some of the property nodes include properties derived from properties of the reservoir model, and store data that define the subvolumes, the surfaces and the meshes. A pillar grid may represent at least one fault, which may confound seismic modeling by presenting geometric inaccuracies. The one or more computer-readable media can include instructions to build fault surfaces and thereby assist with conversion of faults a pillar grid.

As described in more detail below, conversion techniques may expose one or more intermediate surface nodes at a fault and may project faulted pillars into a two-dimensional domain where the two-dimensional domain preserves z-coordinate information of each of the faulted pillars. For example, to project faulted pillars to reduce fault representation from three-dimensions to two-dimensions and to compare a transversal edge of one side of a fault to a transversal edge of another side of the fault to identify intersecting transversal edges.

Conversion techniques may allow for building one or more surfaces selected from a group consisting of fault surfaces, horizon surfaces, external surfaces and undefined cell surfaces. As to mesh generation, a technique may tessellate each of the subvolumes independently, which may optionally occur in a distributed manner to distribute tessellating of the subvolumes to reduce time required to tessellate all of the subvolumes.

As described herein, a method can include accessing data that define a pillar grid where nodes of the pillar grid define logical cells of a reservoir model; partitioning the pillar grid into subvolumes where each of the logical cells is mapped to one of the subvolumes; building surfaces to define boundaries for each of the subvolumes where each of the surfaces comprises polygons where each polygon comprises associated surface nodes; based on the surface nodes, for each of the subvolumes, tessellating a mesh of property nodes; performing a simulation of one or more physical phenomena using the subvolumes, the surfaces and the meshes, where at least some of the property nodes comprise properties based on properties of the reservoir model; and storing at least some results of the simulation for subsequent visual presentation with respect to the reservoir model.

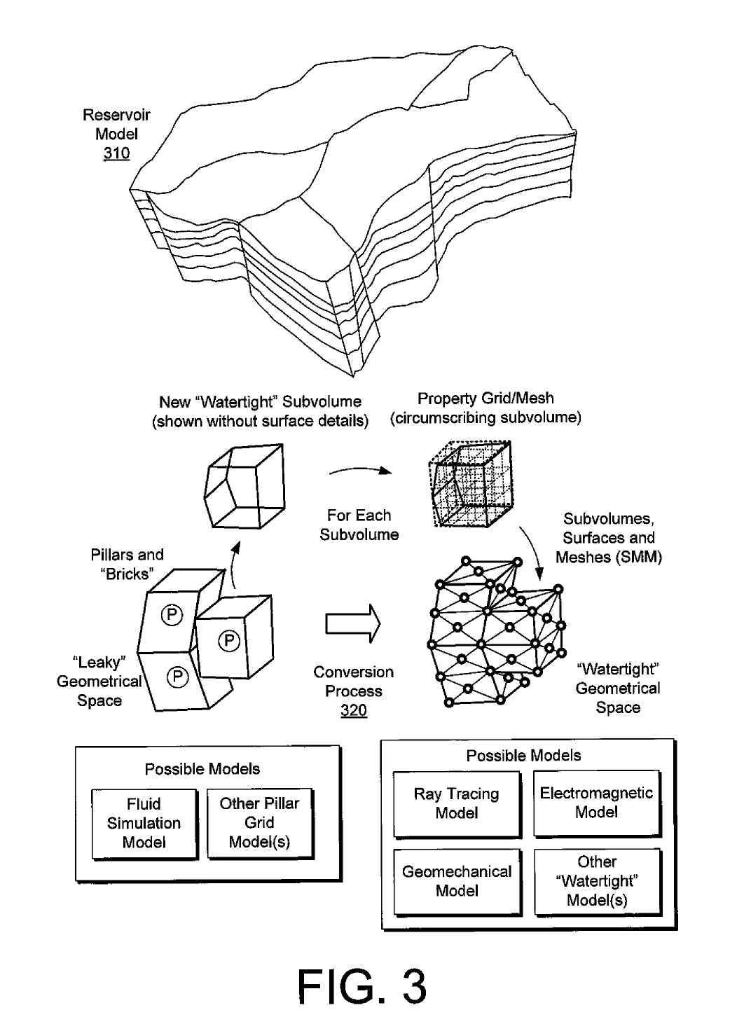

FIG. 3 shows a reservoir model 310 that may be provided as a pillar grid model of pillars that define cells (or “bricks”). A conversion process 320 converts the pillar grid model to a SSM model that is “watertight” in a geometrical space. In the example of FIG. 3, a subvolume is shown as having a circumscribed mesh. In this example, the surfaces of the subvolume can be used to extract the portion of the mesh that overlaps with the subvolume. As mentioned, a Volcan model largely decouples property and geometry; hence, as shown, the subvolume and surfaces define geometry while the mesh defines one or more properties.

The pillar grid model may be suitable for fluid modeling or other types of modeling. The converted model may be suitable for various types of modeling, including, for example, ray tracing, geomechanical, electromechanical, or one or more other types of “watertight” models. In general, the converted model is suited for finite element modeling. In many finite element models, an element is defined by nodes that form a volume with surfaces. Properties can be assigned to the nodes and equations that rely on these properties described to ultimately provide solutions to phenomena of interest. For example, a finite element may include equations based on Darcy's law (e.g., as derived from the Navier-Stokes equation) that relates flux through a porous region based on pressure gradient, gravity, etc. The pillar grid model can only approach a solution to such a problem via connecting one cell to another in the logical space, which, again, often does not accurately represent the geometrical space. Finite element methods are typically suited for providing solutions to partial differential equations. Finite element analysis has proven beneficial for study of thermal, electromagnetic, fluid, structural as well as other environments. Finite element methods may include finite difference techniques for introducing time as a dimension.

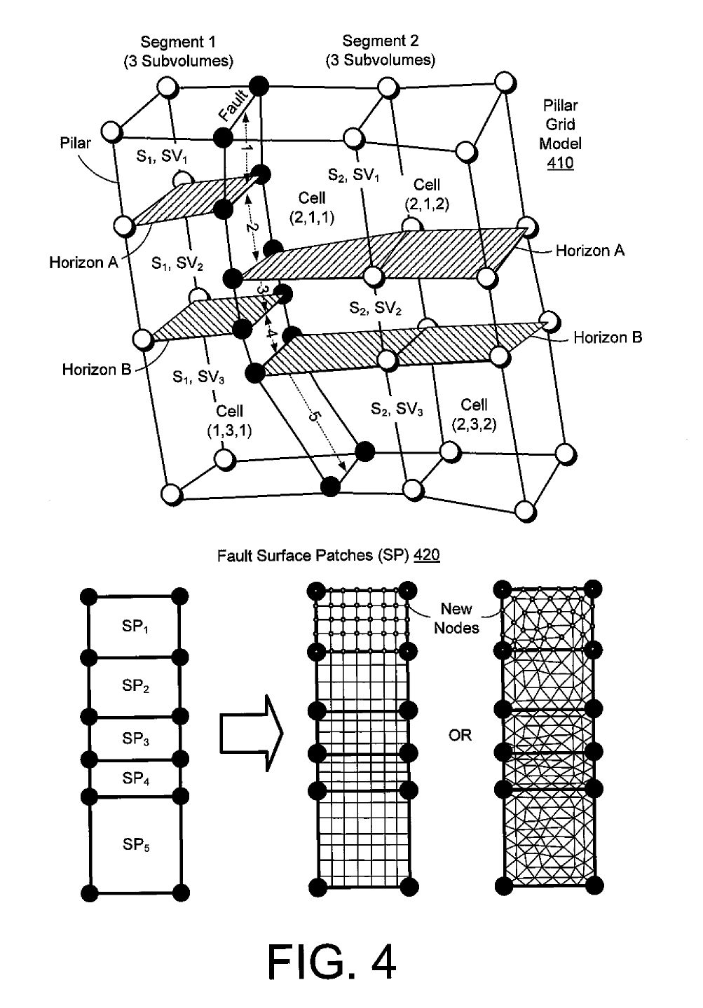

FIG. 4 shows a portion of a pillar grid model to further illustrate and explain aspects of a conversion method. In various models, such as a pillar grid model, a fault is a type of anomaly that prevents some simulation algorithms from running correctly. For example, seismic ray tracing algorithms require two adjacent cells to be geometrically connected, not just logically connected as is the case in a pillar grid. Indeed, where a geometric connection is absent, a ray propagating from the right towards the left will hit the boundary of the cell on the right and will then be unable to proceed because it has reached a void (i.e., because the cell on the left does not occupy that volume). In a pillar grid model, this type of anomaly is due to the curvature of the faulted pillars. The curvature is defined as a space curve, and in most implementations of pillar grids, a curved pillar is defined by the polynomial interpolation of 3 or 5 control points, whereas cell sides are straight triangles connecting nodes on those curved pillars (see, e.g., FIG. 1). This produces a void between the straight boundaries of the cells on each side of the fault.

As described herein, a process of surface building allows for “closing” voids in a pillar grid model. Surfaces, sometimes referred to herein as “patch” surfaces, may be constructed by polygons such as triangles or rectangles. Triangulated or other polygonal surfaces can be built to define boundaries for subvolumes (e.g., from partitioning of a pillar grid model). A subvolume will contain, for example, every triangle of its bounding surfaces. According to the example method 200 of FIG. 2, surfaces of a subvolume are entirely built before generating a property mesh because in that example the surface mesh and property mesh align.

The following example is described with respect to triangulated surfaces. During the construction of the triangulated surfaces, it is helpful to account for the required or desired characteristics of these surfaces. For example, consider the following three characteristics:

1. The surfaces must be watertight. Visually this means that if one has the perspective of being inside a volume, there is no possible path leading outside the volume without breaking the connection between two triangles. Formally this means that for any edge of any triangle of the boundary of a volume, there is another distinct triangle sharing that same edge. This formal characteristic of water tightness is actually a way of performing a quick check of the output of this algorithm.

2. The intersection of any two distinct triangles of the set of surfaces is reduced to either a single apex or a complete edge. In other words, this characteristic means that two triangles cannot intersect in any way other than by sharing a node or a complete edge.

3. A surface must have at least one and at most two volumes on its side. This characteristic must be met as a part of Volcan surface topology criteria. The side of a triangulated surface is defined by normal vectors of each of its triangles. The positive side is in the direction pointed to by the normal vector of the triangle.

To gain efficiency and to guarantee a correct triangulation (i.e., a triangulation that respects the geometry defined by a pillar grid), a method can include building surfaces based on existing topological elements of a pillar grid. For example, a method can triangulate the following surfaces sequentially:

1. Fault surfaces. These surfaces are based on the faults in a pillar grid. They are the surfaces marking the discontinuities in the geometry of a pillar grid, and are patchworks of fault faces, which are the geometrical overlap between the cells on each side of a fault. These surfaces should be built first to keep track of intermediate points that can arise and be necessary to build watertight surfaces. This process has a complexity cost on the order of n^{2/3} where “n” is the number of cells in the pillar grid.

2. Horizon surfaces. Horizon surfaces are surfaces built based on horizons in a pillar grid (i.e., all the nodes of the grid having the same rank). To triangulate these surfaces, one can consider cells having the same “k” index value and triangulate their top or base. A method can add into the triangulation correct intermediate points that were uncovered and tracked during a fault surface triangulation. Horizon surfaces can impose some additional tracking issues as they can be collapsed (e.g., one surface upon another). Horizon surfaces have a cost on the order of n^{2/3}.

3. External surfaces. External surfaces are surfaces that compose a border of a pillar grid. External surfaces are generated by triangulating sides of cells that are on a boundary of a pillar grid (i.e., those whose index is on a face of the logical Cartesian regular grid containing the pillar grid). The top and base of the grid, even though it is an external cell, is considered by convention as a horizon surface, and is treated as such. Therefore only the right, left, back and front of a regular grid are considered external surfaces. They have a cost on the order of n^{2/3}.

4. Undefined cell surfaces. Undefined cell surfaces are boundary surfaces between defined cells and undefined cells. They are composed of a patchwork of the common cell side between a defined cell and a neighboring undefined cell. They have a cost on the order of n.

For the foregoing four surface types, the cost values pertain to approximate algorithmic costs. Algorithmic complexity analysis considers inputs of infinite size to compare asymptotical costs, omitting multiplicative constants. In practice, it turns out that the multiplicative constants matter in this case because they are low for the expensive undefined cells boundary surface, and very high for the fault and horizon surfaces. This is based on the run times of an implementation of this algorithm that shows, empirically, that the most expensive surfaces to build are the fault surfaces, because they are not necessarily based on the triangulation of given cell sides. In terms of expense, fault surfaces are followed by horizon surfaces, because they require twice as many dictionary lookups than the boundary surfaces.

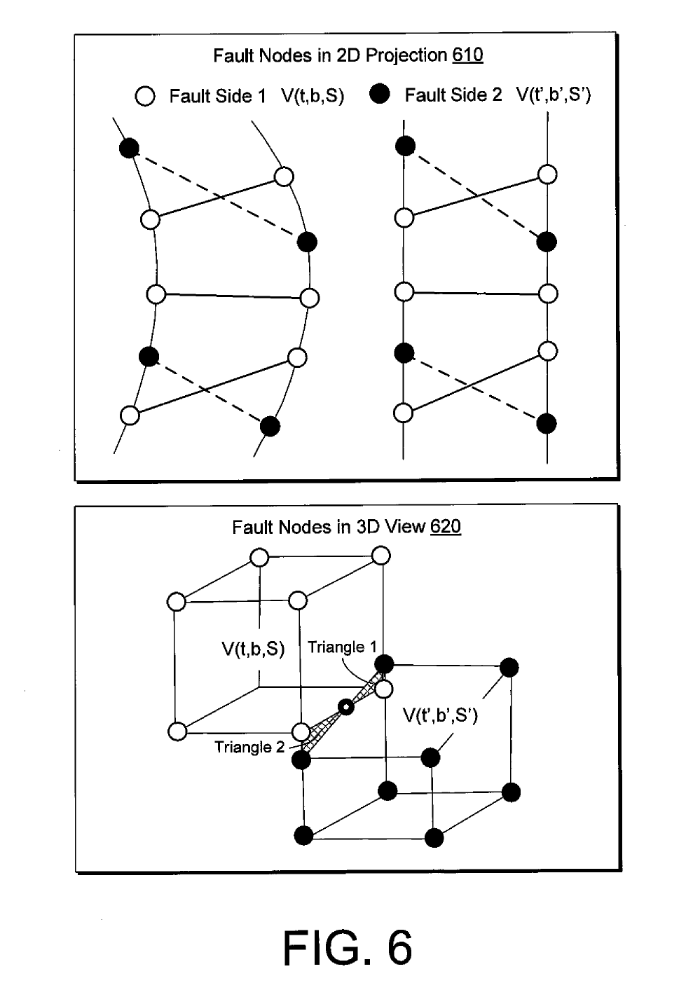

As described herein, a conversion method can build fault faces that represent overlap between cells separated by a fault as illustrated in FIG. 4, which shows five fault surface patches (SP₁ to SP₅). Determination of the faces of a fault surface can be a complex operation in 3D geometric space because, due to the pillar curvature, gaps or overlap can appear between cells on each side of a fault. Faults and horizons may meet at varying angles due to the various degrees of freedom of the natural geology. The pillar grid issues confound geometrical computations on the grid to determine the faces. Furthermore, in general, work cannot be performed in the logical domain because it does not represent the discontinuities. Specifically, the grid in the logical domain is simply a regular grid that masks the geometric properties of the discontinuities, which is why, in building the fault faces, projection occurs for all the faulted pillars into a hybrid domain in which the original geometrical z values of the nodes on the pillars are retained, while the x (or “i”) and y (or “j”) coordinates are dropped, giving them virtual arbitrary values that are unique for each pillar (for use in a conversion algorithm). For example, by replacing x and y by the pillar indices (see lower portion of FIG. 4 as well as FIG. 6), pairs of overlapping cells are preserved and it is much easier to determine aspects of the fault as an original 3D problem has been transformed into a 2D problem.

Referring again to FIG. 4, the nodes along the two pillars of the fault form pairs where a line between the nodes of each pair does not intersect a line between two nodes of another pair. This represents a fairly straightforward scenario. More complicated scenarios are discussed with respect to, for example, FIG. 6 where a horizon (e.g., plane) may meet a fault at an angle and result in intersection of lines between pairs of nodes.

As shown in FIG. 4, the surface patches 420 may be broken into rectangles or triangles (e.g., to form surface meshes). An edge of one surface patch includes nodes that are shared with an edge of another surface patch, for example, see the “new” nodes in SP₁ along the edge with SP₂. In such a manner, the patches are connected in the 2D projection as well as in the 3D problem space. Further, it becomes apparent that the first Cell of Segment 2, Subvolume 1, labeled (2,1,1), includes surface patches SP₁ and SP₂; noting that SP1 corresponds to a cell in Subvolume 1 of Segment 1 and that SP2 corresponds to a cell in Subvolume 2 of Segment 1. As the formation of nodes on the surface patches may be chosen to dictate tessellation of volume elements in the cells (e.g., to define a property mesh), the approach of FIG. 4 guarantees that geologic discontinuities can be adequately handled during simulation. This is in stark contrast to the logical nature of the pillar grid that has voids along a discontinuity.

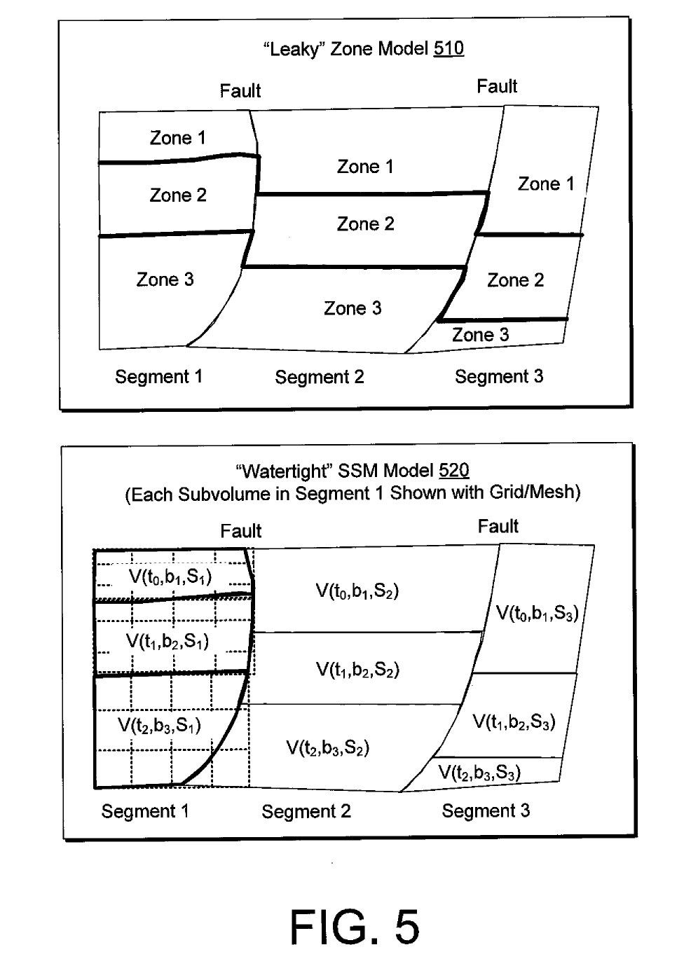

FIG. 5 shows an example of a “leaky” zone and segment model 510 that can be converted to a watertight SSM model 520. The watertight SSM model 520 demonstrates how bookkeeping may be achieved, for example, using subvolumes defined by a tuple: t, b, S where t represents a “top” horizon index under which horizon the subvolume lies, b represents a “bottom” horizon index over which horizon the subvolume lies, and S represents a segment index for the segment containing the subvolume. Accordingly, each subvolume can be represented or referenced by its (t, b, S) tuple. With reference to the pillar grid 410 and surfaces patches 420 of FIG. 4, a conversion method can rely on such an overall scheme for purposes of describing, analyzing, storing, etc., information associated with a watertight SSM model. In the example 520, three property meshes are also shown for the three subvolumes in Segment 1. In this example, overlap occurs between meshes. As mentioned, defined surfaces of a subvolume can be used to cut any excess property mesh (i.e., to extract only the information germane to the subvolume).

As mentioned with respect to FIG. 4, another issue may arise when some vertices of a fault face are not described by a cell vertex of a pillar grid. This issue arises when a horizon on each side of a fault intersect (e.g., forming an X pattern). The intersection point is an extra point that must be accounted for when building surface patches. In various examples, the extra point is called an intermediate point because it has no existence in the logical domain and, accordingly, is not a node of the horizon or the cell and further it does not necessarily lie on a cell edge either. The issue acknowledges that since the point is not a node of the pillar grid, it does not enter directly into the set of points constituting the horizon surfaces, resulting in a non-watertight junction between horizon surfaces and fault surfaces.

FIG. 6 shows an example of fault nodes in a 2D projection 610 and fault nodes in a perspective 3D view 620 where a horizon or horizons may intersection a fault. For purposes of analysis, a projection 610 in a geometrical domain (left side) may be transformed to a hybrid space (right side). As shown in FIG. 6, lines between pairs of nodes intersect; a situation that was not exhibited in the example of FIG. 4. Where such intersections occur, additional steps must be taken to form surface patches. For example, as shown in the 3D view 620, two triangular regions are formed due to the intersecting lines. Triangle 1 pertains to the “overlap” between volume (t, b, S) and volume (t′, b′, S′) bounding the fault and requires a different approach than Triangle 2, which pertains to a gap between volume (t, b, S) and volume (t′, b′, S′). Logically, Triangle 2 is akin to Triangle 1 but for a different volume is involved (e.g., a volume above V(t′, b′, S′)). The perspective 3D view 620 is also referenced further below as to cell side triangular.

As described herein, an approach to surface patches for the example of FIG. 6 involves building a half edge data structure. The half edge data structure is built by inserting all the transversal edges (the ones going from one pillar to the other and joining two nodes of the same rank) from one side of the fault, followed by the ones from the other side, checking to see if they intersect an edge from the first group as inserted. It is noted that inserting all the transversal edges from one side at the same time without checking for intersections is a valid operation because, based on the definition of the rank, two transversal edges lying on the same side of a fault do not geometrically intersect: they can only be identical, share an apex or be completely different.

In this approach, when inserting edges from the other side, they must be compared to the transversal edges on the first side so that it is possible to eventually split the edges if they are intersecting. Such an intersection test is readily accomplished in one-dimension, but to gain in performance, transversal edges are inserted in increasing rank order while keeping track of the highest rank of the intersecting opposite edge. According to this approach, when the first edge (that has a rank of zero) is inserted, a comparison for the opposite edges (starting the search at rank zero) is performed where one of these intersecting edges will have a higher rank (e.g., for instance a rank of 3). The rank is kept in memory. Now, where insertion of an edge of rank 1 occurs and it is desired to find the opposite intersecting edge, an algorithm can start by checking if the edge 3 of the opposite side is above or intersecting. If the latter case, then the algorithm may just check the indices immediately above 3 until it finds the topmost intersecting opposite edge, and if the former case, the algorithm need not check all the edges above 3, because it is known that since 3 does not intersect, they will not intersect either.

According to the aforementioned half-edge approach, a half-edge data structure exists with transversal half edges inserted: each node on a pillar is doubly linked to either the corresponding node on the opposite pillar or to an intermediate point representing the edge intersection. An algorithm can complete the building by adding all the connection information for nodes on a same pillar. An algorithm can also remove the connection information going from the left pillar to the right one for the top edge(s), and the connection information going from the right to the left pillar for the bottom edge(s).

Once the half-edge data structure is built, it is possible to start creating the fault faces. A particular approach uses an “always turn left rule” (e.g., as used in 2D maze problems). According to this approach, each time an intersection is encountered, a left turn is made in the 2D plane. Such an algorithm may start by choosing an arbitrary half edge linking “A” to “B” and apply the rule to find, among all half edges the B edge, the correct one.

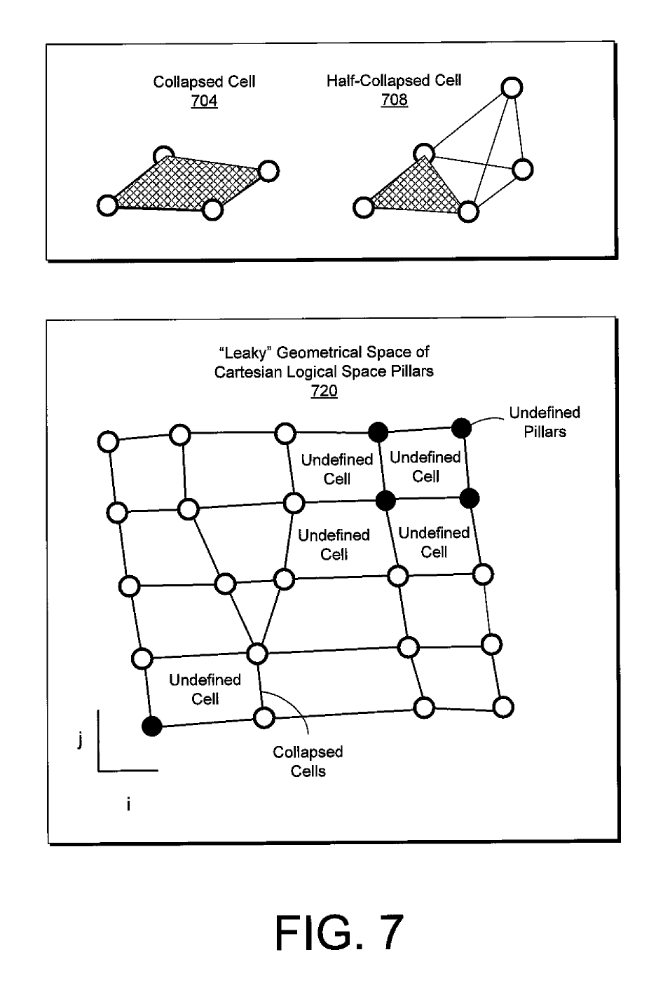

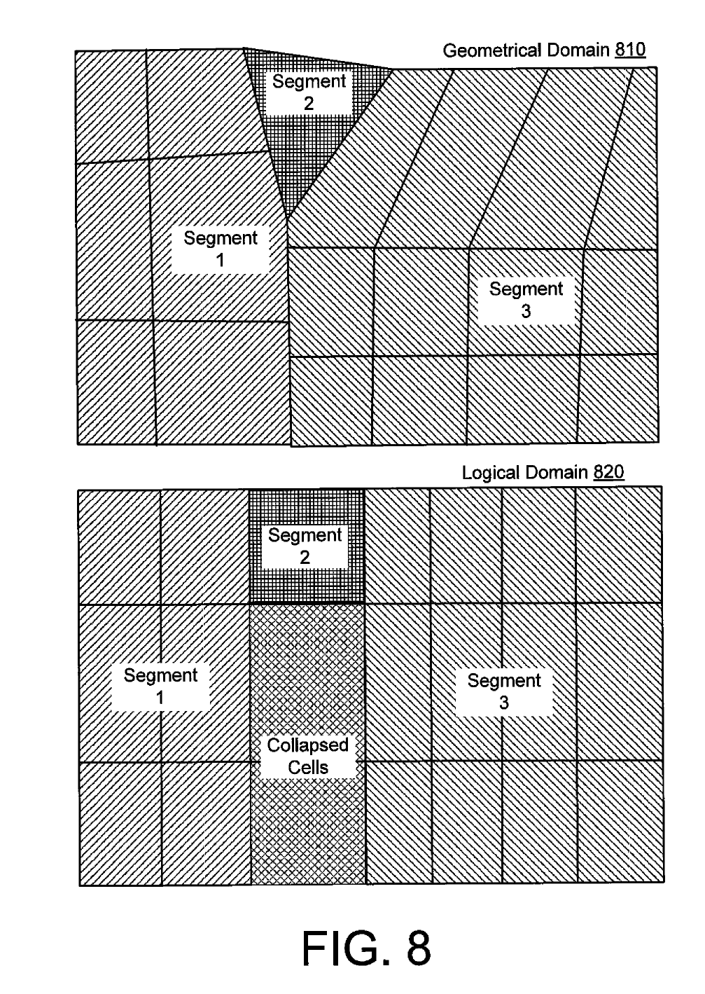

To complete building of a fault face, an algorithm determines which fault surface the fault face belongs to, for example, by using a mapping function that maps each cell index to a volume. Accordingly, by determining the two cell indices on each side of the fault face, the algorithm provides the pair of volumes on each side, yielding the surface that links these two volumes. However, if the cell immediately on the side of the fault is collapsed, some errors might arise. This issue is illustrated and described with respect to FIG. 8, after a brief explanation of collapsed cells with respect to FIG. 7. In the example of FIG. 8, all of the cells except the top one in a central segment (Segment 2) are collapsed on the fault due to the presence of a Y fault.

Collapsed cells arise due to the fact that formal definitions of pillar grids generally authorize degenerate grids to be considered as valid. As various techniques aim to convert a pillar grid to a SMM model using, for example, a constrained Delaunay triangulation algorithm, validation or checking is required of the pillar grid to uncover and address situations to ensure that triangular constraints are non-intersecting. Accordingly, to fill a mesh with tetrahedrons using a Delaunay triangulation algorithm, the surface building part of the process must output non self-intersecting surfaces. Since the formal definition of a pillar grid does not exclude this type of geometrical problem, the need for a validation process exists. For example, as mentioned a validation process can check an input grid for degenerate cells, flag their positions and eventually apply one or more algorithm that try to correct associated flaws.

As shown in FIG. 7, geometrical flaws that can occur in pillar grid models include collapsed cells 704 and half-collapsed cells 708, for example, due to degenerate nodes. The formal definition of a pillar grid allows for the nodes on a pillar to be identical (degenerate), thus allowing collapsed and half-collapsed cells to appear in the pillar grid. A collapsed cell 704 is a cell which has all its top four nodes collapsed on their respective bottom nodes. The cell then has no volume. A half-collapsed cell 708 is a cell where only three of the top nodes are collapsed with their respective bottom nodes.

Collapsed and half-collapsed cells can produce errors in surface triangulation. Indeed, surfaces may not link the correct subvolumes together, in the case of collapsed cells, and in the case of half-collapsed cells, only half of the triangles will have the correct topology. For example, given a stack of cells labeled volume 1, volume 2 and volume 3, where the middle cell (volume 2) is collapsed, a surface (volume 1 to volume 2 surface) is also collapsed onto another surface (volume 2 to volume 3 surface) thus creating self intersection for a boundary of the middle cell and a situation where links to adjacent volumes in the collapsed zone do not exist. A correct triangulation would include a hole in collapsed surfaces around the collapsed region and create an additional surface (volume 1 to volume 3 surface) in that region.

FIG. 7 also shows a top view (i, j plane) of a pillar grid with undefined pillars, undefined cells and collapsed cells. As mentioned, such issues can be identified via a validation process that may determine if an algorithm should be applied to address the situation, as appropriate, such that the pillar grid can be properly converted to a SSM model.

As mentioned, FIG. 8 shows a so-called Y-fault in a geometrical domain 810 and in the logical domain 820. In the example of FIG. 8, all of the cells except the top one in the central segment (Segment 2) are collapsed on the fault due to the presence of the Y fault. If one were to use the directly adjacent cell indices for the triangulation of the lower fault faces, the result would be a mapping of the resulting triangles to the wrong surface (in this case, they would have been mapped to the surface linking Segments 1 and 2 instead of the surface linking Segments 1 and 3).

To address the Y-fault problem, an algorithm fetches the next uncollapsed cell in that direction and uses it to determine which volume is geometrically next to the fault face. If there is no next uncollapsed cell, then that fault face is either facing the exterior of the grid or is an undefined cell. In either of the foregoing cases, the algorithm can drop the fault face because the external or undefined boundary surfaces will triangulate those cell sides and generate the appropriate surfaces. This is important because if the fault faces are triangulated twice (once in the current process and once in the coming boundary surface building process), the triangulation will have intersecting triangles and prevent tetrahedral tessellation for that volume.

As mentioned with respect to FIG. 4 (see, e.g., surface patches 420), a method may use triangles or rectangles or other polygons for surfaces. Below, some examples are described with respect to triangles.

Triangulating a fault face in 3D can be problematic where corners of a fault face may be intermediate points (i.e., not necessarily cell corners). If one considers two fault faces sharing an edge, the relative position of the two vertices of the common edge in the lists of corner points of the respective fault faces will be reversed. In simpler terms, from one side of the fault, looking at the ordering of the corner points of each of the fault faces, it becomes apparent that ordering is either always counter-clockwise or always clockwise.

To triangulate in 3D is complicated due to the fact that orientation of a point relative to a segment does not exist. In other words, it is not possible to state that a point is on the left or on the right of a given line. This confounds triangulation of the fault face given the restriction that triangles do not intersect each other. Further, when a fault face is concave, it becomes numerically difficult to determine if a given triangle is good or not. Accordingly, projecting points onto a plane and triangulate the resulting 2D polygon provides an option to proceed with a conversion of a pillar grid model.

In a particular example, an algorithm defines a projection plane as the plane containing the three points of a corner list for which the surface of the corresponding triangle is maximal. This heuristic strongly assumes that the maximum distance of the face corners to this plane is much smaller than the size of the projected polygon. This assumption essentially considers the fault faces as nearly planar relative to their size.

Once projection occurs for the fault face corners onto the plane, the algorithm can triangulate the polygon with a sub-algorithm such as the ear cutting algorithm (ECA). The ECA can iterate over clockwise-ordered vertices of a 2D polygon until it finds three consecutive vertices for which the third one is on the left of the line defined by the two previous ones. The ECA then creates a triangle out of those three vertices and removes the middle vertex. It then starts iterating again until there are no more vertices left in the polygon. Other algorithms implemented in various geometrical libraries may be used where choice of the ECA, in the foregoing example, is based on the fact that point sets are always small (a fault face can only have a maximum of 8 points), accordingly loss in performance is not drastic compared to implementation time.

Fault surfaces are the representation of the geometrical discontinuities in a grid. Fault surfaces differ from other surfaces because the point set used for the triangulation is not composed of only points taken from corners of a pillar grid's cells. In general, intermediate points are also used. A fault surface is a patchwork of fault faces, which are the overlap between two cells on each side of a fault. As a consequence, the problem of triangulating the fault surface is reduced to building and triangulating the fault faces. Such a process was explained briefly with respect to the surface patches 420 of FIG. 4.

As described herein, a method can include building triangulated fault faces between two volumes (e.g., subvolumes). To build the fault surfaces from pillar grid data, an algorithm can keep track of an already created set of surfaces by generating a hash-based dictionary that maps a pair of volumes to a surface linking those two volumes. According to this approach, for each fault face, it is possible to search the dictionary to see if an entry already exists with the pair of volumes attached to the fault face, and to create it if it does not exist. Triangles can then be assigned to the fault face of that surface.

Cell side triangulation generally involves two cells and the points used in the different triangulations. With reference to the 3D view 620 of FIG. 6, consider the nodes of V(t, b, S) and the nodes of V(t′, b′, S′) as well as the intermediate point due to the fault between the cells (hollow circle).

Cell-side triangulation is the process of triangulating the point set composed of the four corners on the same side of a hexahedral cell with the additional intermediate points that come from the fault faces located at the intersection of a horizon and a fault surface, as well as the points coming from different sides of the same pillar. In the 3D view 620 of FIG. 6, to triangulate the front side of the cell V(t, b, S), its cell corners are used as well as a cell point from V(t′, b′, S′) that is between two corners of V(t, b, S) and on the back common pillar. For the triangulation of the top side of the cell V(t′, b′, S′), the four cell top corners as well as the intermediate point are used.

By adding these points in the point set, a conversion algorithm ensures that the horizon, external and undefined surfaces described earlier are watertight relative to the fault surfaces built in the prior step. Indeed, during the fault surface building, a dictionary is stored with the edges of horizon cells that had intermediate points on them. This allows an algorithm to fetch, in constant time (e.g., where it is a hashed dictionary), the edges needed to integrate into a triangulation process. Fetching the points from all the sides of a pillar can be implemented as a direct operation on the pillar grid data structure, which makes it very efficient.

Triangulation of cell sides can occur in the logical domain rather than in the geometrical one to take advantage of any existing tessellation of the pillar grid. Such an approach provides efficiency because an algorithm need only work with numerous small sets of points avoiding the use of exact geometry. For example, the order of magnitude for a large reservoir model (Gullfaks model) is about 6 million sets of 4 to 6 points to triangulate. If one were to abandon the existing connectivity information, and tried to do surface reconstruction, the CPU cost might be too high.

In the logical domain, a cell side can be represented by a square that has intermediate points on its edges. While there exist many ways to triangulate such a square, a conversion method aims to find a triangulation that is also valid for the geometrical cell side. To achieve this goal, a divide and conquer algorithm that recursively splits the cell side can be implemented that include performing checks in decreasing order of priority to choose the diagonal for the initial split:

1. The diagonal must be chosen so that the two triangles do not intersect each other. This is accomplished by projecting the non-shared point of the second triangle onto the plane defined by the first, and checking if the projection is within the first triangle.

2. The diagonal must be chosen, if possible, so that neither of the triangles has two edges on a fault surface. Since this would usually lead to a flat triangle in the geometrical domain, it is best to try to prevent it. If both or none of the diagonals are suitable, it is possible to continue. However, if one and only one is found, then that one is used.

3. For horizons only, the diagonal must be chosen so that it does not intersect any of the above horizons. Unless this is the topmost horizon, in which case the process can continue with the next criterion, a check may occur that checks if the maximum altitude of the current point set is below the minimum altitude of the point set of the horizon cell above. If this is the case, the process can try to use the next criterion. Otherwise, the process can use the same diagonal that was used to triangulate the horizon cell above.

4. Use the diagonal that maximizes the minimum area of the two generated triangles.

At this point, a process has now split an initial square into two triangles that can be referred to as the main triangles, which may have intermediate points on their edges. Of course, in the geometrical domain, two of the points may very well be identical. If this is the case, a process can drop the flat triangle that would be generated and jettison the extra vertex, keeping only distinct vertices. Even though a technique has been implemented to try to prevent it, a very rare situation can occur, when two of the vertices of the square have identical coordinates and every edge of the cell is surrounded by faults.

Given the two main triangles, a process can now continue with splitting each of these triangles. To split a main triangle, an edge of the main triangle can be selected where the edge has the most intermediate points and then proceed by splitting along the line drawn from the middle point of that edge to the opposite triangle apex. This forms another two triangles that can then be recursively split using the same approach. A stopping criterion for such a recursive triangulation is when there are no more intermediate points on the triangle edges.

In practice the aforementioned heuristic works well because the intermediate points are never far away from the edge that they are supposed to belong to. Most of the cell sides that are triangulated have four distinct corners, no intermediate points, and have a relatively good shape (i.e., a convex square-like shape, where either of the initial diagonal choice works fine). For these cells, the algorithm returns immediately, and triangulation is trivial. A predominant cost in foregoing triangulation process involves determining which type of situation exists (e.g., is it a normal cell side, or does an algorithm need to flip diagonals because of neighboring faults?)

Horizon surface building can occur based, in part, on a given efficient algorithm to correctly triangulate a cell side. However, due to the third diagonal selection criteria, an algorithm is generally constrained to build at the same time all the horizons in a same cell stack (all the cells that have the same i and j indices) because knowing which diagonal was used for triangulation of the above horizons in the same cell stack is useful.

For the k-th horizon in a given cell stack, an algorithm fetches the top of the (i, j, k) cell (or the base of the (i, j, k−1) cell if k is the bottom most horizon of the pillar grid. The cell side can be triangulated according to the approach described above for cell side triangulation. A characteristic of the aforementioned triangulation approach is that each of the triangles generated is inside one of the two main triangles. This characteristic allows an algorithm to find the volume geometrically above or under the triangle in order to resolve the half collapsed-cell geometrical issue (see pillar grid anomalies described above) and map the triangle to the correct surface.

To map a triangle in a cell side triangulation to the correct surface, an algorithm can consider the main triangle containing the triangle. For example, the corresponding main triangle has its vertices on three of the pillars surrounding the cell. To determine the volume (e.g., subvolume) that is above (respectively below) a horizon surface, an algorithm is configured to compute distance in indices between k and the next distinct node having an index inferior (respectively superior) to k. The algorithm can then call for keeping only the minimum value of that distance over the three pillars. If this minimum value is less than the distance between k and the horizon immediately above (respectively below), then the surfaces are not collapsed. Otherwise they are collapsed, and the correct volume is found by counting the number of horizons that are at a shorter distance.

As mentioned, a pillar grid typically has some finite boundaries defined by “external” facing cells. The surfaces for these cells can be built in a rather straightforward manner. For example, for a grid of logical dimension (Nᵢ, Nⱼ, Nₖ), we simply consider all the cells having an index (i, j, k) that meets one of the following criteria: (a)=Nᵢ or i=0; (b) j=Nⱼ or j=0; or (c) k=Nₖ or k=0.

If, and only if, the cell is defined and uncollapsed, will the algorithm triangulate the cell side that is facing the exterior of the grid using, for example, the process described in cell side triangulation. If the cell side is undefined then the cell will be triangulated during the undefined boundary surfaces building process. If it is defined but collapsed vertically, then the triangles are all flat and there is no need for a surface in that area.

For an undefined cell boundary, an algorithm can loop over all the cells of the grid in a linear pass, and for each undefined cell encountered, the algorithm can check each of its neighbors to see if it is defined or uncollapsed. If it is, the algorithm can then triangulate the common cell side and map the triangles to the appropriate surfaces using the surface dictionary.

While tessellation of a property mesh formed of tetrahedrons, hexahedrons, etc., has been described generally, some particular examples of are described below.

Given triangulated watertight surfaces extracted from geometrical partitioning of a pillar grid, a property mesh based on volume filling with tetrahedrons may proceed together with assignment of point and connectivity information.

A method can include tessellation of each volume defined by bounding surfaces. The minimum requirement for tessellation is that all the triangles of the bounding surfaces are contained by a subvolume. Tessellation can generate a simple regular grid, a constrained mesh, etc. As mentioned, in general, interior points of a subvolume, as based on points of bounding surfaces, are referred to herein as a mesh. Accordingly, after tessellation, a SSM model suitable for finite element or other types of watertight modeling results; noting, however, that property assignment to the nodes of the mesh occurs prior to simulation (e.g., whether a conventional numerical technique or an inverse numerical technique is implemented).

Volume building has associated costs and typically the highest overall cost for a conversion method. However, in the example below, an algorithm is specifically configured to allow parallelization of workload. In this example, each volume (e.g., subvolume) is tessellated independently from other volumes, and since models typically have many volumes, workload distribution can be applied.

Volume generation includes point fetching; as described herein, points are nodes for the mesh that is generated and will be assigned properties, for example, according to the properties of the pillar grid model. Some situations may arise where additional or alternative properties are assigned to nodes, which may not be included in the original pillar grid model.

In a particular example, a first step in a volume generation process is to fetch all the points from the initial pillar grid contained within a particular volume (see, e.g., the SSM model 520 of FIG. 5). With the partition used to define a volume (e.g., a volume being the intersection of a Zone and a Segment), points may be directly fetched corresponding to a given volume. For example, an algorithm may fetch eight corners of the cells located in a given segment and in a given zone. Fetching the eight corners of the cells is, however, quite inefficient because, for a given node, it will be fetched eight times, once for each of the surrounding cells.

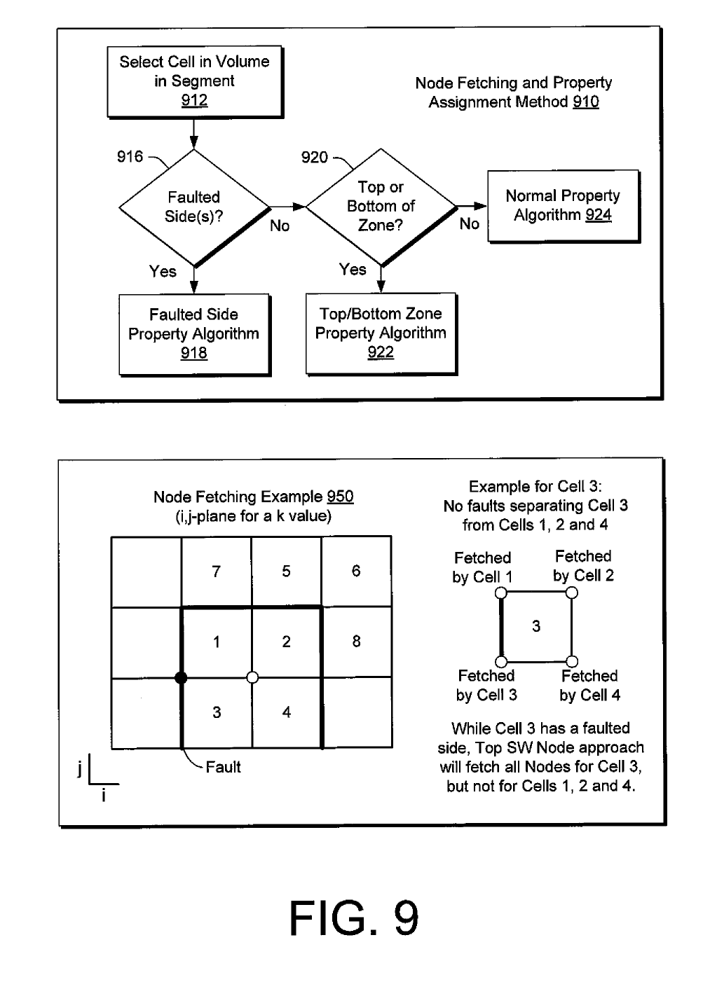

An alternative approach is shown in FIG. 9 with respect to a node fetching and property assignment method 910. The method 910 includes a selection block 912 for selecting a cell in a volume in a segment (see, e.g., the indexed subvolumes of the SSM model 520 of FIG. 5). A decision block 916 decides whether the selected cell has one or more faulted sides. If so, the method 910 continues at a faulted side property algorithm block 918. Another decision block 920 decides whether the selected cell is at the top or bottom of a zone. If so, the method 910 continues at a top/bottom zone property algorithm block 922. If the decision blocks 916 and 920 decide that such conditions do not apply to the selected cell, then the method 910 enters a normal property algorithm block 924.

FIG. 9 also shows an example of point/node fetching 950 with respect to an i, j-plane for a k value. The portion of a model shown in this example includes a fault and various cells, labeled 1 through 8. Cell 3 is taken as a specific example where no faults separate cell 3 from cells 1, 2 and 4. Accordingly, where a single node is fetched (e.g., top southwest corner) for each cell, and specifically cell 3, three of the nodes for cell 3 will be fetched when the algorithm selects cell 1, cell 2 and cell 4. Hence, in this example, only a single node needs to be fetched for cell 3. It is noted that for some other types of cells (e.g., faulted side(s) and top or bottom of a zone), property assignment must account for type of cell.

Accordingly, per the method 910, instead of fetching all the nodes, only one node needs to be fetched (e.g., the top SW node), because the others will be fetched when neighboring cells are individually selected (see, e.g., selection block 912). As mentioned, however, when a selected cell is on the boundary of the volume (for instance at the bottom or top of the zone or next to a fault) there is not necessarily a neighbor to fetch one or more of that cell's nodes. Accordingly, the decision block 916 and 920 test to see if a selected cell has one or more faulted sides, or if it is on the top or bottom of a zone, in which case one or more algorithms (e.g., algorithms 918 or 922) include adding corner points that will not be inserted by neighbors.

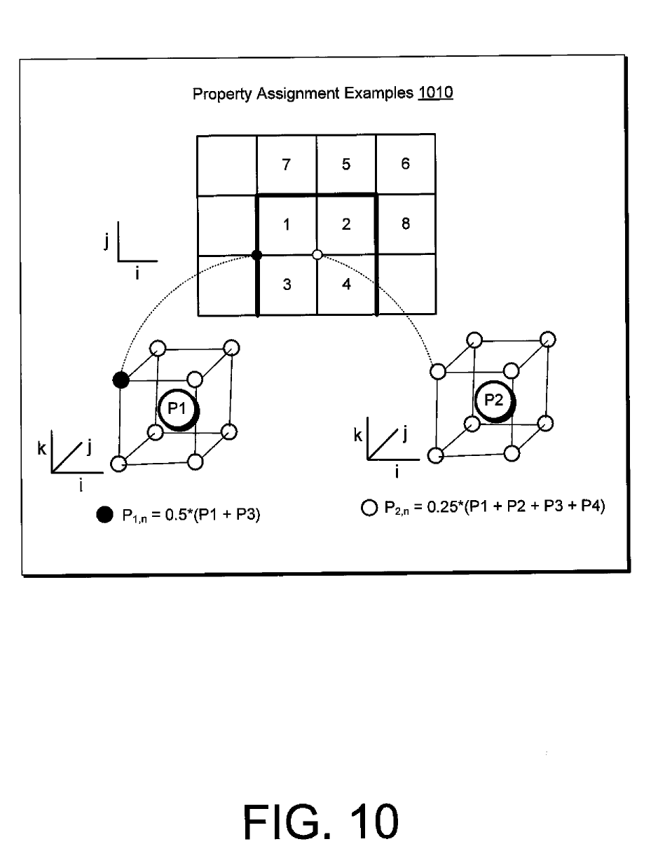

As mentioned, for the example of FIG. 9, node fetching and property assignment are considered together. FIG. 10 shows two examples of property assignment 1010 for a node of cell 1 and for a node of cell 2 for the portion of the model shown in the example 950 of FIG. 9. For cell 1, the lower left node lies on the fault and will be assigned properties based on an average of cell centered properties of cells 1 and 3 of the pillar grid model. For cell 2, the lower left node does not lie on a fault and it will be assigned properties based on an average of cell centered properties of cells 1, 2, 3 and 4.

As explained, the lower left node of cell 1 is the upper left node of cell 3. Further, the upper right node of cell 3 will be fetched when cell 2 is selected, and the lower right node of cell 3 will be fetched when cell 4 is selected. This information is available because it is known that there are no faults separating cell 3 from cell 1, 2 and 4 and therefore they are in the same segment (assuming in this 2D illustration they are in the same zone, although in 3D, this is easily checkable by comparing the k-index of the cell to the zone's top and base k-indices).

For cell 1, on the other hand, if an algorithm only fetches the bottom left corner, then the upper, left corner will not be fetched by cell 7 because it is in a different segment. This issue exists for cell 2 and requires that all of its corners be fetched because the upper-right cannot be fetched by cell 6, the upper left will not be fetched by cell 5 and cell 8 cannot fetch the lower right corner either.

As mentioned, for the method 910 and examples 950 and 1010, when an algorithm fetches a node, it also computes the properties that are associated with that node. For seismic wave simulation, properties are typically continuous properties such as density or wave velocity, which can be assigned to individual nodes based on averaged property values of associated cells in a pillar grid model. As explained in the example 1010, averaging can be cell-volume-weighted averaging based on properties of neighboring cells that are in the same zone and in the same segment. The faulted side property algorithm block 918 of the method 910 may be configured to perform the averaging operation explained with respect to cell 1 in the examples 1010; whereas the normal property algorithm block 924 may be configured to perform the averaging operation explained with respect to cell 2 in the examples 1010.

To avoid inserting duplicate nodes/points, a particular method can use a division table to track the nodes/points already inserted in a volume. In this example, the division table is a data structure similar to a regular grid that can be superimposed over the volume. When an algorithm inserts a point in the division table, it can be automatically inserted in the containing cell of the regular grid. The index of the cell can be computed as follows:

nᵢ=[floor(x⁽ⁱ⁾)−x_{orig}⁽ⁱ⁾]/ΔXᵢ

where x_{orig}⁽ⁱ⁾ is the i-th component of the origin of the regular grid, x⁽ⁱ⁾ is the i-th component of the inserted point, ΔXᵢ is the length of the grid along the i-th axis, and nᵢ is the cell index along the i-th axis.

According to the above example, checking if a point has already been inserted is then reduced to checking the points in the cell of the regular grid. This approach only checks for exact duplicates. If a point is ε away from another point then they are considered to be distinct points. To prevent “slivers” being inserted into a volume, a method may include checking for previously inserted points not necessarily at the exact same position but in a small neighborhood around a geometrical position.

The method 910 can include fetching and inserting points from bounding surfaces where, even though they may not carry property values, they can be located within the volume to ensure continuity in geometry and prevent voids from appearing between volumes.

As described in various examples as to fetching nodes (or points), a data structure is created composed of pointers to bounding surfaces and a set of points, where depending on the ultimate use of the SSM model, at least some of the points can have assigned property values. A next step includes generating connectivity information for a node (or point) cloud, which defines basic elements (e.g., tetrahedral, hexahedral, etc.).

As mentioned, the connectivity between points may form regular meshes, unstructured tetrahedral meshes, etc. Efficient algorithms have been designed and integrated in Volcan models for population of regular meshes based on point clouds. However, the same is not true for meshes generated by Constrained Delaunay Tetrahedralization (CDT); their tessellation requires attention in the management of the nodes and tetrahedrons generated.

The input of a CDT is a point cloud and a set of indexed triangulated surfaces, based on that point cloud. These constraint surfaces must meet some requirements in order to define a valid meshing domain. First, they must be watertight, meaning that there must not be any open face. In other words, there is no path starting from inside a volume (e.g., a subvolume) that exits the volume without going through a triangle of the constraint surface. Another requirement is that these surfaces must be non self-intersecting, meaning that the intersection of any pair of distinct triangles in the constraint surfaces must be either null, or equal to a shared edge. Two triangles share an edge when two points are apexes of both the triangles. As explained, various techniques can generate surfaces that meet these requirements, and thus can be used as constraints. Finding the correct set of constraining surfaces for a given volume “v” comes down to finding the surfaces that store a pointer to “v”.

Not all polyhedral meshing domains admit a CDT and additional points, called Steiner points, might need to be added in order to allow tessellation. A very simple example of an unmeshable domain is Schönhardt's polyhedron, which is formed by rotating slightly the top triangle of a triangular prism. This can raise issues because the additional points can be numerous, and their location unknown prior to the tessellation. Moreover they do not have any properties attached, so tracking of these points and interpolate of properties onto them can be required.

In general, a criterion for selecting a good mesher is often subjective. A mesher can be chosen that is fast and efficient, or saves memory, or is robust, no matter how long it takes to generate the mesh. However, the minimum requirement for all meshers is that they respect the boundary of the domain, and that no input points are deleted.

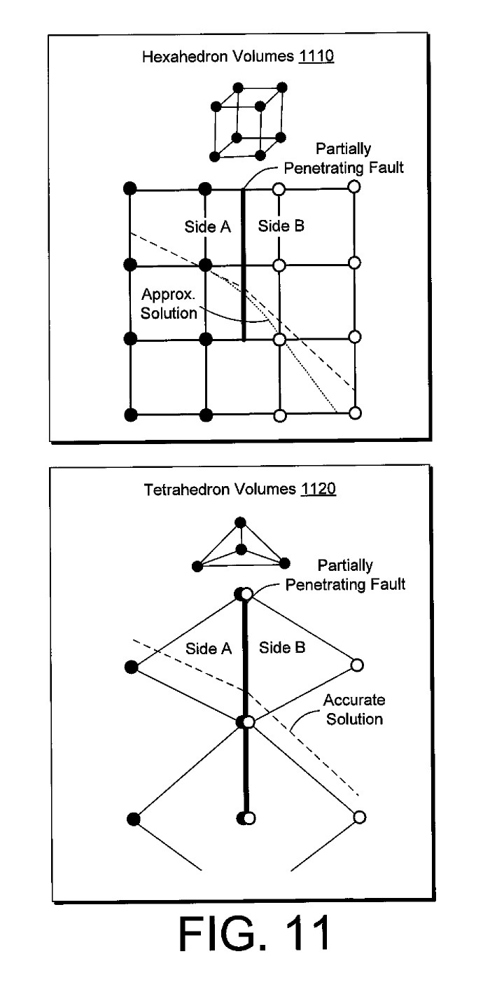

As described herein, another issue can arise with Partially Penetrating Faults (PPF). FIG. 11 shows an example 1110 of a rectangular mesh with a PPF between Sides A and B and an example 1120 of a triangular mesh with a PPF between Sides A and B. As mentioned, the constraining surfaces should be non-self-intersecting. However, for the tetrahedral property representation to be efficient, the faces on the PPF need to be duplicated with their nodes. One copy of the face and node would be owned by side A of the PPF, and have some properties assigned, whereas the other face and nodes, would be owned by a tetrahedron on side B of the PPF, and have different property values, even though the geometry is the same. Since this defines an invalid input for a CDT, a few possibilities are examined as explained below.

Since all the triangles on the PPF are flagged and contained within a unique surface for a given volume, an algorithm can include duplicating the PPF surface, and storing in each of the copies the correct property values. Once tessellation is complete, it is possible to fetch the tetrahedrons that have a face on the PPF and fix their connectivity information. While this approach can be rather tedious, it has an advantage of leaving the geometry untouched.

Another approach includes duplicating and opening very slightly the PPF, so that it becomes a sharp but an open “U” shaped fault. The goal of this approach is to prevent the PPF from being a self intersecting surface. Once the tessellation is complete, the two sides of the fault can be repositioned to their original location. This approach disturbs the geometry and care should be taken to not invert any tetrahedrons. In other words the tessellation of the disturbed vertices must be the same as the one of the non-disturbed vertices. Moreover, the tetrahedrons on the PPF get “squeezed”, which makes more room for floating point errors.

The type of volume tessellation used is entirely dependent on the model and the preferences of the user. A tetrahedral volume is an unstructured mesh. It is unstructured, as opposed to regular logical grids, because the indices of its elements (the tetrahedrons) do not contain geometrical information. In a regular grid, an (i, j, k) index references a particular brick in the grid which is always neighboring the (i+1, j, k) brick. Hence, geometrical information is given by the indices, which is not present in an unstructured mesh.

The main advantage of tetrahedral meshes is that they can be generated out of point clouds (e.g., node clouds) and indexed triangulated surfaces based on that point cloud, so that each point in the cloud is an apex of a tetrahedron in the mesh, and that each triangle of the surfaces is a face of a tetrahedron. In other words, it is possible to force a constraining surface to appear in the mesh, to respect the boundaries of a domain for instance. A particular generation process is called constrained Delaunay tetrahedralization. It is a popular triangulation process because Delaunay tetrahedrons tend to have good shapes according to height ratio criteria and tend to be more suitable for finite element simulations.

In various cases, respecting constraining geometry is a feature that can give more accuracy to a model in complex geometries. For instance, partially penetrating faults make fault networks complex and regular grids cannot accurately represent the discontinuity of properties through a PPF. In a regular node centered grid, for any continuous path contained within it, properties are continuous along the path.

Referring again to FIG. 11, the examples 1110 and 1120 provide a comparison of ray behavior at a PPF in a regular grid 1110 and in a tetrahedral mesh 1120. The expected ray is dashed and the error is exaggerated for illustration purposes.

Consider a scenario where a PPF separates two zones of a volume such that the velocity property has different values on each side of the fault, but is fairly constant on each side of the fault. For a ray propagating in the volume from left to right (i.e., from A to B), it is possible to analyze the ray path for both examples 1110 and 1120. In the example 1110, where a regular Cartesian grid is used to represent the volume, because the property gradient is nearly null in the left zone, the ray travels in a straight direction. However, once the ray enters the cell intersected by the PPF surface, the gradient becomes very strong because it is, in this case, interpolated between two nodes from the left zone, and two nodes from the right zone, that have different values. However, even if it is not the case for the gradient, the velocity is still continuous, and the ray follows a circular path while still in the left zone, instead of being refracted on the fault interface. Once the ray hits the fault, Snell's law is applied. However, seeing that it is the same volume on the left and the right side and that the ray enters the exact same cell it just left, the velocity value on the other side of the surface is equal. Hence, the ray does not refract. It continues in the right part of the intersected cell on the same circular path it followed in the left part, until it reaches the boundary of that cell. Once it leaves that cell, it follows a straight path once again, seeing that the velocity value is once again constant. The dashed line is the expected ray path and the error is noticeable.

For the example 1120 of FIG. 11, consider the exact same ray, and the exact same PPF, but now the volume is represented by a tetrahedral mesh in which there is a discontinuity across the PPF. Unlike in the model of the example 1110, there is a true discontinuity of the velocity value along the ray path on traversal of the fault. The cause of this discontinuity is that topologically, the ray virtually exits the mesh through the free face of tetrahedron A, and re-enters the volume through tetrahedron B, which is a different tetrahedron than the one it just left. In consequence, the ray follows a straight path within tetrahedron A, all the way up to the PPF, because the gradient is computed with the property values on the nodes of A (which are all equal), and follows a straight path within tetrahedron B for the same reason. The ray is correctly refracted at the interface because the value of the velocity is different. Accuracy gained by using tetrahedral meshes is paid by a longer CPU cost for the tessellation process. The Delaunay tetrahedralization is an operation on the order of nᵥ², where nᵥ is the number of points in the input.

Where tessellation of the volumes (e.g., subvolumes) uses a constrained Delaunay triangulation, additional Steiner points are inserted in the point cloud. In addition, some of the points that were already present in the input set and that came from the constraining surfaces did not have properties. These additional points can be numerous. For example, a test data set with complex geometries containing 70000 points added 30000 additional points during tessellation process, mainly on the boundary of the meshed domain. Such conditions can justify a need for an efficient interpolation of properties on the remaining nodes.

A particular approach aims to interpolate properties onto a node by using all the tetrahedrons for which that point is an apex. Seeing that the only information in a data structure are the points and the indexed tetrahedrons, a first step is to build a neighbor dictionary that provides a list of indices of all the tetrahedrons sharing that node. This dictionary is a hashed one, and maps point indices to an array of tetrahedron indices. Using the hashed dictionary provides a quick lookup method for points; noting that as an alternative, an array of exactly the same length as the point cloud array may be created.

In a trial, a conversion method was applied to an existing Gullfaks pillar grid model (a standard demonstration model of Schlumberger). The pillar grid was converted and ray traced using sources randomly placed within the model. This approach to ray tracing benefits from a background model that accounts for the overburden, for example, to bring rays down from the surface to the reservoir.

As described herein, hybrid models can be formed using various techniques. For example, two different models can be used to represent a geologic subsurface: Volcan models to support seismic processing and pillar grid models to support downstream fluid flow simulations. These two models have different strengths and weaknesses. For instance, the pillar grid model typically represents a reservoir more accurately because the model includes much post-seismic data interpretation. Volcan models, on the other hand, can describe complex geobodies, such as salt domes, which pillar grids cannot. By dividing a model into sub-models, it is possible to use the best of each type, and make them work together, thus enhancing the modeling compatibility. For instance, to simulate surface seismics in a reservoir zone, one can now, using the conversion algorithm described above, benefit from the more accurate pillar grid model in the reservoir part, while the overburden (necessary to bring rays down from the surface to the reservoir) can be represented by a the Volcan model that was created during upstream processing. The purpose of this merging process is to allow the end user to use the model representation that is best suited for each part of the physical problem.

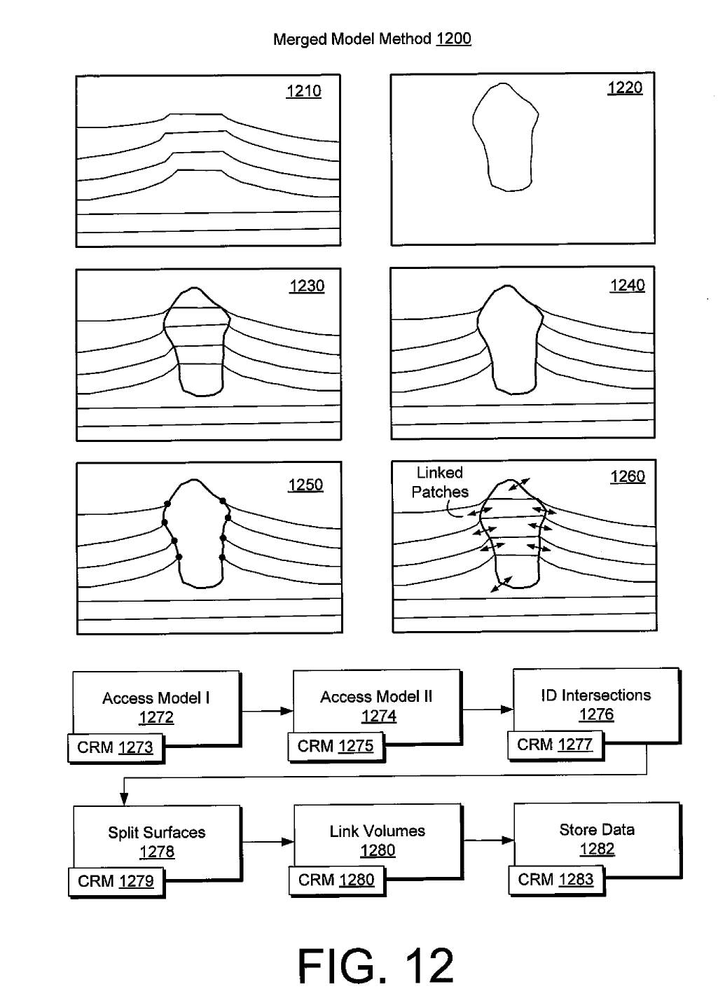

FIG. 12 shows an example of a merged model method 1200. Various diagrams aim to illustrate how two models can be merged. The diagrams represent, from top to bottom and left to right, the background model 1210, the dominant model 1220, the two models overlapped 1230, the boundary surface of the dominant model 1240, the partitioned boundary surface 1250 (see, e.g., markers to indicate partitions), and the re-linked patches of the partition 1260. The method 1200 includes blocks that optionally have one or more corresponding computer-readable medium (CRM) that include instructions for instructing a computing device or devices to perform at least a portion of the method 200. In the example of FIG. 12, various CRM blocks are shown: 1273, 1275, 1277, 1279, 1281 and 1283. While multiple blocks are shown, a single CRM may include instructions sufficient to instruct a computing device (or devices) to perform the actions in each of the blocks of the method 1200.

As described herein, a model merging algorithm can be configured to merge two Volcan models together, each of them being composed of a set of triangulated surfaces and a set of volumes. In the example of FIG. 12, one of the two models is referred to as the dominant model while the other model is referred to as the background model.

The merging algorithm splits the triangulated surfaces connecting the volumes of each model to allow for linking each volume on the boundary of the dominant, foreground model to the appropriate volume in the background model. Linking is accomplished with respect to the surfaces, so the algorithm generates surfaces that respect the Volcan surface topology criteria.

The method 1200 includes an access block 1272 to access data that define a first model of at least a portion of a reservoir and an access block 1274 to access data that define a second model of at least a portion of the reservoir, where the first model and the second model overlap geometrically and where the first model and the second model include surfaces that bound and define volumes. In an identification block 1276, the method 1200 identifies surface intersections between the first model and the second model. A splitting block 1278, based on identification of surface intersections, splits surfaces connecting the volumes of the first model and split surfaces connecting the volumes of the second model. A link block 1280 links each volume on a boundary of the first model to a corresponding volume of the second model using at least some of the split surfaces. In the example of FIG. 12, a storage block 1282 can store data associated with at least the linked volumes, the data sufficient to perform a simulation of one or more physical phenomena using the linked volumes. Such a method may include rectifying one or more artifacts associated with the linked volumes. Further, such a method may include accessing data for more than two models (e.g., to merge more than two models).

Formally, a binary internal operator can be defined ⊕, on the space of all possible Volcan models Ω. In this approach, a convention is set where the second operand is the dominant model, and thus the operator is non-commutable (i.e. M₁⊕M₂≠M₂⊕M₁).

A first step in the algorithm is to over impose the dominant model and the background model. This creates two parallel models that have no knowledge of each other. While a graphical user interface may present a visual representation of the overlapping models, the models, at this time, are not yet linked (i.e., aware of the overlap). Indeed if one is positioned in a volume of M₁, then every surface met takes one into another volume of M₁, and model M₂ is virtually invisible.

To link the two models, bounding surfaces of the dominant model are considered. These surfaces are easy to find since they are the ones having a null pointer as one of the volumes (e.g., subvolumes). Next, these surface pointers are added to the volumes of the background model that they are contained within. However, since there is absolutely no reason for these surfaces to be entirely contained by only one of the background model's volume, it is necessary to split the boundary surface according to the background model's surfaces. This process corrects the dominant model's surfaces so that they meet the Volcan surface topology requirements.

As described herein, a merging algorithm computes surface intersections by checking if surface bounding boxes are intersecting. This quick test can reduce computation time: if the boxes are not intersecting, then the surfaces are not intersecting either. If the surface bounding boxes are intersecting, then a division table of the two surfaces is built. With such a structure, an algorithm may then act to find the intersecting triangles of the two surfaces, for example, by checking cells of the division table that have triangles from both surfaces within them. Such an approach involves doing a minimal few triangle-triangle intersection tests.

Once the pairs of intersecting triangles are found, the algorithm splits them according to the type of the intersection. Possible intersections exist between two triangles. Each triangle subject to a splitting operation is mapped to a surface linking one of the volumes from the background model with one of the volumes in the dominant, foreground model. In some cases where the triangles are coplanar, the triangles that are in the intersection of the two initial ones are mapped to a different surface, a result of the background or foreground volume being different for those triangles. This issue is trivial to fix but must be resolved in order for the intersection computation to be robust. An algorithm may allow triangles to be flagged as inside or outside the dominant model, which can be necessary to resolve to which volume each surface should be linked to.

From a theoretical perspective, if one considers a valid Volcan model V and considers an arbitrary triangulated surface S, then the patches (i.e. the output triangulated sub surfaces) formed by splitting S according to all the surfaces in V are either entirely outside V or entirely contained within a volume of V.

A proof demonstrates that, because two triangles are path connected (i.e. a sequence of connected triangles “T” going from T₁ to T₂), and that according to the definition of a patch, none of the triangles in the sequence are intersecting another surface of V, it can be concluded that every point on that sequence of triangle is within the same volume v₁, thus the patch is entirely contained within v₁.

In the foregoing approach, it is assumed that the dominant model is always in front of the background model. It is possible to have specific parts of the background model to dominate and vice-versa. This can be done easily by preprocessing the background model. If an algorithm extracts from the background model a sub-model containing all the regions desired to be dominant, and with all of its bounding surfaces, then the algorithm can merge the background model with the dominant model as a first step, and then do a second merging process, using the output of the first operation as background, and with the previously extracted sub-model as a dominant one. This resolves the problem by decomposing the merge into two steps.

Various techniques associated with merging may introduce one or more merging artifacts. As described herein, another algorithm may be configured to operate on output to correct and erase any merging artifacts, for example, resulting from inconsistencies between two models.

Artifacts arise because of the ubiquity of the representations of the same physical concepts in each model. Indeed, when models M₁ and M₂ are merged together, they can overlap such that objects in overlapping areas are then represented in both models. However, by convention, in overlapping areas, only one model is dominant and in consequence there is only one representation of a given object. However on a boundary of the two models, at the transition point of the two models, the representation of objects pass from the dominant model representation to the background one or vice versa. If these two representations are not consistent (e.g., if the position of the object changes slightly from one model to the next), then the model will falsely appear to be faulted. For example, a stratified refined model may be over-imposed on a coarser background model. In this example, two main layers could be represented simultaneously in the background model and in the dominant, foreground model. While in the same model, only one of the representations is used, in the transition area between the two models, a slight shift in the depth of the layer can occur that makes it seem faulted. Such a shift is not created by the merging process but by the inconsistency of the models being merged. In this case, a real scenario might be the cause where, for example, seismic tomography has been used on the background model, while the foreground model was further corrected by well measurements, thus creating this slight shift.

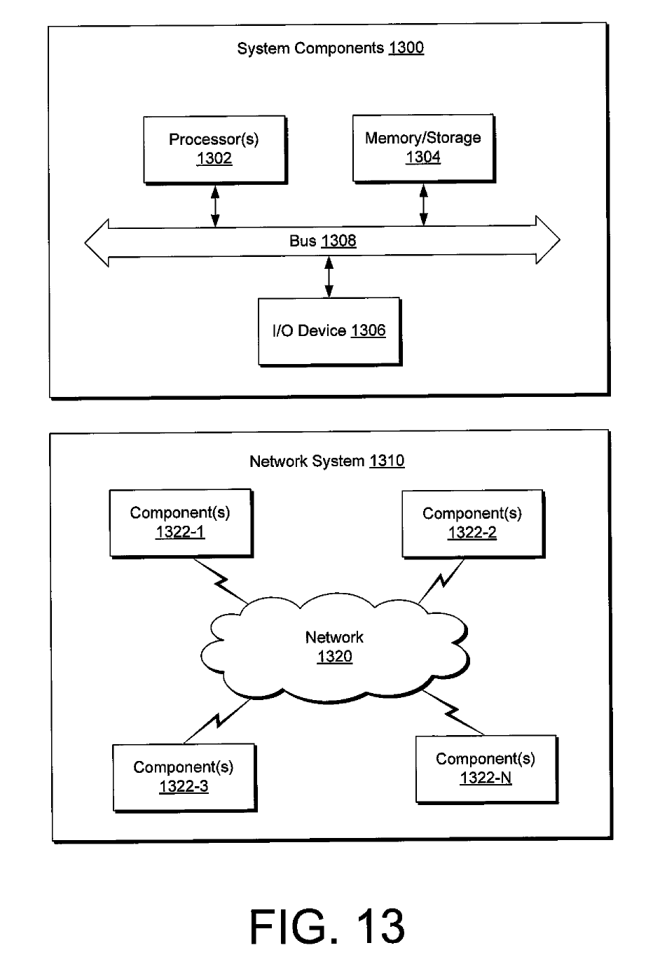

FIG. 13 shows components of a computing system 1300 and a networked system 1310. The system 1300 includes one or more processors 1302, memory and/or storage components 1304, one or more input and/or output devices 1306 and a bus 1308. As described herein, instructions may be stored in one or more computer-readable media (e.g., memory/storage components 1304). Such instructions may be read by one or more processors (e.g., the processor(s) 1302) via a communication bus (e.g., the bus 1308), which may be wired or wireless. The one or more processors may execute such instructions to implement (wholly or in part) one or more methods, techniques, approaches, examples, etc. A user may view output from and interact with a process via an I/O device (e.g., the device 1306).

As described herein, components may be distributed, such as in the network system 1310. The network system 1310 includes components 1322-1, 1322-2, 1322-3, . . . 1322-N. For example, the components 1322-1 may include the processor(s) 1302 while the component(s) 1322-3 may include memory accessible by the processor(s) 1302. Further, the component(s) 1302-2 may include an I/O device for display and optionally interaction with a method. The network may be or include the Internet, an intranet, a cellular network, a satellite network, etc.

### CONCLUSION

Although various methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

1. One or more computer-readable media comprising computer-executable instructions to instruct a computing system to:
access data that define a pillar grid wherein pillar nodes of the pillar grid define logical cells of a reservoir model;
partition the pillar grid into subvolumes;
build surfaces to define boundaries for each of the subvolumes wherein each of the surfaces comprises polygons defined by surface nodes;
generate a mesh of property nodes for each of the subvolumes wherein at least some of the property nodes comprise properties derived from properties of the reservoir model; and
store data that define the subvolumes, the surfaces and the meshes.

2. The one or more computer-readable media of claim 1 wherein the pillar grid represents at least one fault.

3. The one or more computer-readable media of claim 1 wherein to build surfaces, the one or more computer-readable media comprise instructions to build fault surfaces.

4. The one or more computer-readable media of claim 3 wherein to build fault surfaces, the one or more computer-readable media comprise instructions to expose one or more intermediate surface nodes.

5. The one or more computer-readable media of claim 3 wherein to build fault surfaces, the one or more computer-readable media comprise instructions to project faulted pillars into a two-dimensional domain wherein the two-dimensional domain preserves z-coordinate information of each of the faulted pillars.

6. The one or more computer-readable media of claim 1 wherein to partition, the one or more computer-readable media comprise instructions to define each of the subvolumes based on intersection of a zone and a segment.

7. The one or more computer-readable media of claim 1 wherein the subvolumes comprise subvolumes indexed by a tuple that comprises an upper horizon index, a lower horizon index and a segment index.

8. The one or more computer-readable media of claim 1 wherein to partition, the one or more computer-readable media comprise instructions to define a hash function and to generate volume dictionaries using the hash function.

9. The one or more computer-readable media of claim 1 wherein the surfaces comprise watertight surfaces.

10. The one or more computer-readable media of claim 1 wherein the surfaces comprise triangulated surfaces.

11. The one or more computer-readable media of claim 1 wherein, for the surfaces, each edge of one of the polygons is shared with another polygon and at least one node of each of the polygons shared with at least one other polygon.

12. The one or more computer-readable media of claim 1 wherein to build, the one or more computer-readable media comprise instructions to build one or more surfaces selected from a group consisting of fault surfaces, horizon surfaces, external surfaces and undefined cell surfaces.

13. The one or more computer-readable media of claim 2 further comprising instructions to project faulted pillars to reduce fault representation from three-dimensions to two-dimensions and to compare a transversal edge of one side of a fault to a transversal edge of another side of the fault to identify intersecting transversal edges.

14. The one or more computer-readable media of claim 2 further comprising, for a fault, instructions to build a half-edge data structure.

15. The one or more computer-readable media of claim 1 wherein to generate a mesh, the one or more computer-readable media comprise instructions to tessellate each of the subvolumes independently.

16. The one or more computer-readable media of claim 15 wherein to tessellate, the one or more computer-readable media comprise instructions to distribute tessellating of the subvolumes to reduce time required to tessellate all of the subvolumes.

17. A method comprising:
accessing data that define a pillar grid wherein nodes of the pillar grid define logical cells of a reservoir model;
partitioning the pillar grid into subvolumes wherein each of the logical cells is mapped to one of the subvolumes;
building surfaces to define boundaries for each of the subvolumes wherein each of the surfaces comprises polygons wherein each polygon comprises associated surface nodes;
based on the surface nodes, for each of the subvolumes, tessellating a mesh of property nodes;
performing a simulation of one or more physical phenomena using the subvolumes, the surfaces and the meshes, wherein at least some of the property nodes comprise properties based on properties of the reservoir model; and
storing at least some results of the simulation for subsequent visual presentation with respect to the reservoir model.

18. One or more computer-readable media comprising computer-executable instructions to instruct a computing system to:
access data that define a first model of at least a portion of a reservoir;
access data that define a second model of at least a portion of the reservoir, wherein the first model and the second model overlap geometrically and wherein the first model and the second model comprise surfaces that bound and define volumes;
identify surface intersections between the first model and the second model;
based on identification of surface intersections, split surfaces connecting the volumes of the first model and split surfaces connecting the volumes of the second model;
link each volume on a boundary of the first model to a corresponding volume of the second model using at least some of the split surfaces; and
store data associated with at least the linked volumes, the data sufficient to perform a simulation of one or more physical phenomena using the linked volumes.

19. The one or more computer-readable media of claim 18 further comprising instructions to rectify one or more artifacts associated with the linked volumes.

20. The one or more computer-readable media of claim 19 further comprising computer-executable instructions to instruct a computing system to access data that define a third model of at least a portion of a reservoir.
